(19) United States
(12) Patent Application Publication
(10) Pub. No.: US 2010/0018343 A1
(43) Pub. Date: Jan. 28, 2010

(54) Steering Wheel For A Vehicle And Method For Producing The Same

(75) Inventors: Martin Grikschat, Aschaffenburg (DE); Bernhard Kempf, Kleinwallstadt (DE); Norbert Müller, Aschaffenburg (DE)

Correspondence Address: FITCH EVEN TABIN & FLANNERY, 120 SOUTH LASALLE STREET, SUITE 1600, CHICAGO, IL, 60603-3406, US

(73) Assignee: TAKATA-PETRI AG, Aschaffenburg (DE)

(21) Appl. No.: 12/439,460

(22) PCT Filed: Aug. 30, 2007
(86) PCT No.: PCT/EP2007/007582

§ 371 Date: Feb. 27, 2009

(30) Foreign Application Priority Data
Aug. 30, 2006 (DE) 10 2006 041 386.5

(51) Int. Cl. B62D 1/06; B62D 1/04; B32B 37/02

(52) U.S. Cl. 74/558; 74/552; 156/245

(57) ABSTRACT

A method is provided for producing a steering wheel for a vehicle, especially for a motor vehicle. The method according to one form of the invention comprises the following steps: producing a steering wheel frame having a hub base, a steering wheel rim and at least one spoke by providing a hub insert, injection-molding a plastic matrix around the hub insert to give the hub base, the hub base having a hollow shape forming the interior and reinforcing structures being arranged in the interior of the hub base, injection-molding and/or gas-assisted injection molding or water injection molding the at least one spoke and the steering wheel rim from the plastic matrix, the at least one spoke connecting the hub base to the steering wheel rim, and at least partially coating the steering wheel frame with a coating. The invention also relates to a steering wheel produced by this method.

The present invention relates to a method for producing a steering wheel for a vehicle according to the preamble of claim 1 as well as a steering wheel for a vehicle according to the preamble of claim 15.

The steering wheels known from the prior art mainly consist of two components, a steering wheel frame and a steering wheel cover. The steering wheel frame serves as a structural component for absorbing the steering forces and for support in the event of a crash. Conventionally, steering wheel frames are made of metals, in particular non-ferrous alloys. Steering wheel frames made of steel or steel-non-ferrous combinations are also known.

The steering wheel cover as a design element serves for providing the shape and surface of the steering wheel as well as providing the desired haptic properties of the steering wheel. Conventionally, a polyurethane integral foam system is used as a steering wheel cover. The two methods for producing the steering wheel frame and the steering wheel cover are very different and have a negative effect on one another, which is why the production of the steering wheels of the prior art is physically separated into the production of the steering wheel frame and the attachment of the steering wheel cover. This leads to additional costs for labeling, transport, receiving inspection and testing and possibly additional necessary cleaning of the steering wheel frame before attaching the steering wheel cover.

A steering wheel is already known from DE 75 31 072 U which mainly consists of plastics. This steering wheel is characterized, in particular, by a very solid steering wheel rim and a similarly solid steering wheel hub which leads to a high intrinsic weight of the steering wheel. The solid steering wheel hub of this steering wheel does not represent a hub base with a cavity-like internal region.

A steering wheel made of plastics is known from DE 41 08 973 A1 which is produced by means of a costly production method. Thus according to this publication the steering wheel frame is firstly injection-molded, in order subsequently to be press-stretched. As a result of this press-stretching and the alignment of the plastics molecules associated therewith an increased stability of the steering wheel is achieved.

A plastics steering wheel is known from FR 2 620 996 A1 which comprises a solid metallic steering wheel hub. The plastics, parts of this steering wheel are produced by means of a pressing method.

The object of the present invention is to provide a simple method for producing a steering wheel, substantially consisting of plastics as well as a steering wheel which may be produced by such a method.

This object is achieved by a method with the features of claim 1. Such a method is characterized in that firstly a steering wheel frame, consisting of a hub base, a steering wheel rim and at least one spoke, is produced. To this end, firstly a hub insert is provided and subsequently a plastics matrix is injection-molded around this hub insert. In this manner, a hub base is formed from the hub insert. Moreover, from the same plastics matrix the at least one spoke and the steering wheel rim are formed by injection-molding and/or gas-assisted injection-molding and/or water injection-molding. The steps of the injection-molding of the plastics matrix around the hub insert as well as the injection-molding and/or gas-assisted injection-molding and/or water injection-molding of the at least one spoke and the steering wheel rim are preferably carried out simultaneously in one operating step. In other words, after providing a hub insert only one further operating step is required in order to form a steering wheel frame. In this case, it is conceivable and provided that the at least one spoke and the steering wheel rim are both produced by the same method variant (for example injection-molding) or by respectively different method variants (for example injection-molding the at least one spoke and gas-assisted injection-molding the steering wheel rim). Subsequently, the steering wheel frame is covered at least partially by a cover. This takes place, in particular, in the regions of the steering wheel rim and the at least one spoke.

The hub base obtained by means of the method has a cavity-like shape forming an internal region. This shape may also be denoted as cup-shaped. The internal region defines a receiver. Thus the hub base is suitable for receiving further motor vehicle components (for example an airbag module). For improved stabilizing of the hub base, it comprises reinforcing structures facing its internal region which preferably are not visible from the outside (from the vehicle interior).

If the steering wheel rim is produced by means of gas-assisted injection-molding or water injection-molding, a closed hollow profile is produced without ribbing in the steering wheel rim region. The stability of the steering wheel rim is in this case established by the thickness of the steering wheel rim wall. In this method, the gas and/or the water is introduced into the plastics to be shaped.

Optionally, the hub base, which is able to undertake the functions of a body cover and thus is visible without further cladding directly in the interior of a vehicle (the outer face of the hub base thus directly forms a part of the outer contour of the steering wheel), is preferably painted before the at least partial covering of the steering wheel frame with a cover.

Also, preferably before the at least partial covering of the steering wheel frame with a cover and preferably after the possible painting of the hub base, if required, a layer of a resilient material is applied to the steering wheel frame. Whether such a layer is applied or not has to be decided according to the type of cover.

The method according to the invention is preferably embodied such that the entire constructional space of the steering wheel is used for achieving stability of the steering wheel and for ensuring force transmission to the steering wheel and through the steering wheel. This is achieved, amongst others, by the individual spokes of the steering wheel being interconnected by integral injection-molding onto the hub base. As a result, a plastics component is produced which uniformly absorbs the force and, as a result, reduces the individual loads on the spokes. Moreover, the hub base may be designed such that it is directly injection-molded in the desired external geometry. Additional cladding is omitted in this case. The hub base also undertakes in this case the function of a back cover.

In order to allow an effective injection-molding of the plastics matrix, the plastics matrix preferably has at least one thermoplastic plastic.

In particular polypropylene, polybutylene terephthalate or a polyamide are considered as thermoplastic plastics, mixtures of these plastics also being conceivable. Polyamides additionally have the advantage that they have greater stability.

In order to increase the overall stability of the plastics matrix, it preferably has a component of approximately 5 to approximately 80%, in particular a component of approximately 10 to approximately 70% and quite particularly a component of approximately 20 to approximately 60% of a fiber material.

Preferably carbon fibers, metal fibers, fibers of organic products and/or glass fibers are used as fibers of the fiber material. As glass fibers, in this case, both short glass fibers, long glass fibers and endless glass fibers may be used. When using short glass fibers, in particular, cellular plastics are used, in order to compensate for the drawbacks in the stability of the shorter glass fibers. Short glass fibers have a length of approximately 0.1 to approximately 0.6 mm, long glass fibers have a length of approximately 0.6 to approximately 100 mm, and endless glass fibers have a length of greater than approximately 100 mm.

In order to be able to use the advantageous stabilizing properties of the glass fibers, the glass fibers preferably have a diameter of 1 to 60 μm, in particular a diameter of 3 to 40 μm and quite particularly a diameter of 5 to 20 μm.

If a conventional plasticizing unit of an injection-molding machine is used for melting the fiber-reinforced plastics matrix, in which the plastics matrix is melted together with its fiber reinforcement, preferably care is particularly taken that the fiber-reinforced plastics matrix is melted carefully. It is only possible in this manner to transfer the glass fibers in a careful manner through the conveyor worm of the melt casting machine, the plastics region and the heated injection channel into the injection mold. Only by such careful treatment, however, is it possible to introduce the long glass fiber-reinforced plastics matrix into the injection mold such that, in the finished steering wheel frame, preferably at least 50% of the glass fibers have a length of at least approximately 1 mm, in particular a length of approximately 1 to approximately 20 mm and quite particularly a length of approximately 1 to approximately 5 mm. However, such a length leads to the best results in terms of stability of the steering wheel frame.

If the stability of a plastics matrix made of a thermoplastic polymer and a fiber material is applied according to the length of fibers used, it is possible to identify that from a fiber length of approximately 1 mm a marked increase in the stability is achieved which indeed rises with increasing fiber length, this rise in stability however leveling out markedly beyond a fiber length of approximately 3 mm. The increase in stability of the plastics matrix achieved by fibers with a fiber length of more than 5 mm is—measured against the cost which has to be implemented in order to maintain such a fiber length in the event of mechanical stress of the fiber-reinforced plastics matrix—no longer as advantageously useful as the rise in stability in a fiber length range of approximately 1 to approximately 5 mm.

In order to damage the fiber material in the plastics matrix as little as possible, for injection-molding an extrusion device is preferably used, which has at least one supply device for supplying the plastics matrix and/or a plastics matrix component and a conveyor worm for conveying the plastics matrix and/or the plastics matrix component, the regions thereof, which are flowed through by the plastics matrix to be melted and/or by the melted plastics matrix, having cross sections which are as large as possible. In this manner, shear forces acting on the fiber-reinforced plastics matrix may be minimized. It is also advantageous to use vibrators for avoiding blockages in the conveyor worm and/or in the supply device of the extrusion device of the plastics matrix to be melted.

In order to ensure particularly careful handling of the fiber material, the method is preferably carried out such that a fiber-free plastics matrix component and the fiber material are introduced separately from one another into the extrusion device. In this case, the plastics matrix component is firstly melted and the fiber material is introduced into the already melted plastics matrix component. In this variant of the method the conveyor worm practically has no effect on the length of the fibers. The fiber-reinforced plastics matrix is then only still hindered by the injection cylinder and the shear in the sprue and runner and in the molded body. With a separate supply of the fiber material and the fiber-free plastics matrix component, provided long fibers are used, more than 50% of fibers are regularly observed with a fiber length of more than approximately 1 mm in the injection-molded steering wheel frame.

As, in the method according to the invention, both the steering wheel frame and also the cover consist of comparable materials, in particular both consist of plastics, the steering wheel frame is preferably not washed before it is covered with the cover. The saving of this method step is associated with a time and cost advantage.

The covering of the steering wheel frame with the cover takes place preferably by injection-molding, by a reaction method (such as for example reaction injection-molding (RIM method)) and/or by a manual mechanical method such as for example sewing. With the RIM method at least two reactive liquids are mixed under high pressure and subsequently introduced into a die. In the die they are cured to form a finished plastics component, i.e. the chemical reaction of the curing takes place in the die. The choice of method is determined according to the material to be used for the cover. In this case, the RIM method is suitable, in particular, for polyurethane foam.

Preferably, the cover has a leather and/or textile material, a softpaint and/or injection-molded and/or foamed thermoplastics and/or thermosetting plastics. Thus the cover may, for example, consist of a polyurethane foam. If a leather and/or textile material is used as a cover, a manual mechanical method is provided for sewing the cover onto the steering wheel structure. Depending on the thickness of the material of the cover, in this connection it may be advantageous to introduce an intermediate cushioning layer between the steering wheel frame and the cover.

Generally, the cover is markedly more flexible than the material of the frame and fulfils the requirements for haptics according to the specification.

The object of the invention is also achieved by a steering wheel for a vehicle, in particular for a motor vehicle, with the features of claim 15. Such a steering wheel is, for example, able to be produced with the method according to the invention. Preferred embodiments of the method according to the invention are, therefore, also able to be used on the steering wheel according to the invention (and vice versa). Such a steering wheel has a steering wheel frame, which comprises a steering wheel rim, a hub base and at least one spoke, the hub base being connected to the steering wheel rim by the at least one spoke, and the hub base being arranged inside the steering wheel rim and the steering wheel rim and the at least one spoke substantially only consisting of a possibly fiber-reinforced plastics matrix.

Such a steering wheel is characterized in that the at least one spoke comprises reinforcing structures. Moreover, the hub base has a cup-like shape, which forms an internal region in which reinforcing structures are arranged.

In a preferred embodiment of the invention, the steering wheel rim has an enclosed surface, which surrounds a cavity. The cavity is in this case free of reinforcing structures. This design has the advantage that a cover of the steering wheel frame which is desired for the haptics may become very thin as no “open” regions or regions of the steering wheel rim comprising reinforcing structures of the steering wheel have to be covered. Instead, this alternative the steering wheel rim already has advantageous haptic properties without further covering due to its shape which is circular and annular in cross section.

In an alternative embodiment of the invention, the steering wheel rim—similar to the at least one spoke—has reinforcing structures which stabilize the steering wheel rim.

The reinforcing structures are in this case preferably part of the steering wheel rim and/or the at least one spoke and consist of the same material as the in steering wheel rim and/or the at least one spoke. Preferably, the reinforcing structures have a rib-like design.

In order to achieve an optimal effect of the reinforcing structures in the steering wheel, they are preferably arranged along the load transfer paths in the steering wheel. For determining the course of the load transfer paths in the steering wheel, in particular a computed-assisted calculation is provided.

For improved stabilization (and generally depending on the load transfer paths in the steering wheel), the reinforcing structures are preferably arranged at least partially crossed and/or crossed over. “Crossed over”, in this case, is understood as an orientation of the reinforcing structures to one another in which an X-shaped arrangement results. “Crossed” is understood as an orientation of the reinforcing structures to one another in which a T-shaped arrangement results. In other words, “junctions” of a straight reinforcing structure with a curved reinforcing structure also represent a cross within the meaning of the present invention.

Preferably, the steering wheel rim and/or the at least one spoke has a receiver which is formed by a first side limb, a second side limb, which opposes the first side limb, and a central limb which connects the first to the second side limb.

The receiver of the steering wheel frame and/or the at least one spoke preferably receives at least one portion of the reinforcing structures and/or encompasses said reinforcing structures.

So that the reinforcing structures as structural elements of the steering wheel frame are able to stabilize said steering wheel frame efficiently, the receiver of the steering wheel rim and/or the at least one spoke is preferably formed with an enclosed surface. This additionally has the advantage that the structural elements when viewed on the outer face of the enclosed surface are not visible, as they are preferably arranged on the inner face of the surface remote from the outer face of the surface. The inner face is in this case the face of the surface which is oriented toward the actual receiving region of the receiver in which the reinforcing structures are arranged.

Preferably, the receiver of the steering wheel rim and/or the at least one spoke is designed such that it has a U-shaped form in cross section. The side limbs of the U-shape arranged in the vertical represent, in this case, side regions and/or side limbs of the receiver. The base of the U-shape connecting the side limbs of the U-shape is preferably, as a central limb, the part of the receiver which is oriented upwards as regards the steering wheel, i.e. toward the viewing direction of the driver.

Thus the reinforcing structures in the region of the at least one spoke are preferably arranged at least partially obliquely from a first side limb of the receiver to a second side limb of the receiver of the at least one spoke. Such an at least partially oblique and crossed arrangement of the reinforcing structures stabilizes in particular the side spoke(s) of a steering wheel in an appropriate manner.

In an alternative embodiment of the invention, the reinforcing structures in the region of the at least one spoke are preferably arranged substantially longitudinally and transversely to the opposing side regions and/or side limbs of the receiver of the at least one spoke. This arrangement, deviating from an oblique path of the reinforcing structures, is suitable in particular with one or more central spoke(s) as it easily illustrates the load transfer paths present there.

In order to be suitable for the load transfer paths in the steering wheel rim, the reinforcing structures in the region of the steering wheel rim are preferably arranged at least partially parallel to the side limbs of the receiver of the steering wheel rim and/or transversely to the side limbs of the receiver of the steering wheel rim and/or obliquely from the first side limb to the opposing second side limb of the receiver of the steering wheel rim. In this case it is taken into consideration that the load transfer paths in the steering wheel rim are not distributed uniformly over the entire steering wheel rim, but due to the variable stress of the individual portions of the steering wheel rim vary during a steering and/or driving process.

In order to ensure an increased stability of the hub base and a reliable force transmission from the steering wheel to a steering shaft of the motor vehicle, the hub base preferably has a hub insert which is at least partially embedded in the plastics matrix.

Properties of this type which increase the stability are provided to the hub insert in particular when it comprises at least one metal. Preferably the hub insert consists completely of metal, but may also consist of plastics, the region of the hub insert receiving the steering shaft of the vehicle, therefore, preferably being made of metal and being embedded in the plastics regions of the hub insert.

For the improved embedding of the hub insert in the plastics matrix and for improved force transmission, the hub insert preferably has recesses so that it fills up less than the entire bottom surface of the hub base. These recesses result in an embodiment of the hub insert which is characterized by a plurality of projecting wing-like regions of the hub insert.

So that the hub insert is able to receive the steering shaft of the vehicle, it preferably has at least one first through-passage for receiving the steering shaft, which is not embedded in the plastics matrix.

In order to stabilize this first non-embedded through-passage, the reinforcing structures of the hub base are preferably at least partially arranged in an annular manner around the first through-passage. They extend, moreover, preferably at least partially axially toward the first through-passage. If both annular and axial reinforcing structures are provided, these reinforcing structures cross. Crossed reinforcing structures within the meaning of the present invention are also such structures which do not completely extend over one another, but only form a T-shaped crossed structure.

The reinforcing structures on the side faces of the hub base are preferably substantially arranged in the longitudinal direction of extension of the steering shaft of the vehicle to be inserted into the first through-passage. By means of this arrangement, a very efficient stabilizing of the hub base is ensured.

For increasing the stability of the hub base, the hub insert preferably has at least one second through-passage which is embedded non-positively in the plastics matrix. With the presence of such a second through-passage, the non-positive bonding of the hub insert in the plastics is increased. At the same time, the provision of such a second through-passage leads to a saving of material and thus to a weight reduction on the sides of the hub insert. Thus, more than one second through-passage is preferably provided.

The plastics matrix covers the hub insert completely. In the region of the recesses of the hub insert as well as the first through-passage and possibly the second through-passage, however, the bottom of the hub base has through-passages, even after covering the hub insert with the plastics matrix. For stabilizing these through-passages reinforcing structures are preferably provided surrounding the through-passages.

As a result of the sandwich-like design of the bottom surface of the hub base consisting of the hub insert and the plastics matrix surrounding said hub insert, the stability of the hub base and, in particular, of the bottom surface of the hub base is increased many times. Preferably, the ratio between the material thickness of the hub insert and the material thickness of the bottom surface of the hub base, which is formed by the hub insert and the plastics matrix surrounding said hub insert on all sides, is approximately 5:1 to approximately 1:5. A material thickness ratio of 1:2.5 is in this case particularly preferred. With such a ratio, the advantageous effects of the sandwich-like design of the bottom surface of the hub base may be particularly advantageously utilized.

The hub insert preferably has a markedly lower thickness and/or height than the entire hub base. In other words, the hub insert preferably does not extend over the entire height of the hub base. Thus the hub insert forms particularly preferably only a part of the bottom surface of the hub base; a further part is formed by the plastics matrix surrounding the hub insert. The overall height of the hub base projecting over the bottom surface of the hub base is preferably (in particular substantially and/or significantly) greater than the overall height of the bottom surface of the hub base over the entire height of the hub base. The height and/or the thickness of the hub insert, of the bottom surface of the hub base and of the hub base is in this case respectively the extension of these components extending in the extension of the steering shaft to be received.

The hub insert preferably comprises a flat or disk-shaped design. It may adopt different shapes within the scope of this flat design and be provided with depressions and/or recesses. In the region of a (central) opening of the hub insert, which is intended for receiving a steering shaft, the hub insert may be configured deviating from the flat design (for example by a bushing-like or tubular design in this region) in order to allow an improved guidance and/or a more suitable force transmission from the hub insert (and/or of the hub base, of which the hub insert forms a part) to the steering shaft. The (external) region surrounding the (central) region of the hub insert intended for receiving the steering shaft or steering spindle is preferably anchored in the plastics matrix in order to form the bottom surface of the hub base.

For increasing the stability, the plastics matrix from which the steering wheel frame is made has a component of approximately 5 to 80%, in particular approximately 10 to approximately 70% and quite particularly a component of approximately 20 to approximately 60% of a fiber material.

The fiber material preferably has carbon fibers, metal fibers, fibers of organic products and/or glass fibers. In particular, the use of glass fibers has proved advantageous for the stability of the steering wheel frame. Reference is additionally made to the above explanations.

In order to achieve a particularly high stability of the steering wheel frame, preferably at least 50% of the glass fibers in the plastics matrix of the steering wheel frame have a length of at least approximately 1 mm, in particular a length of approximately 1 to approximately 20 mm and quite particularly a length of approximately 1 to approximately 5 mm.

In order to be able to use as much constructional space of the steering wheel as possible for increasing the stability of the steering wheel, the cover which is not responsible for the stability but for the haptic properties of the steering wheel has a depth and/or thickness which is as small as possible. Thus the cover has preferably only a thickness of approximately 1 to approximately 5 mm, in particular a thickness of approximately 1 to approximately 3 mm and quite particularly a thickness of approximately 1 to approximately 2 mm. When using skin foam technology, for example, a thickness of approximately 1.5 mm is sufficient in order to achieve the desired steering wheel haptics of the steering wheel.

For the advantageous haptic properties of the steering wheel, the cover is preferably made from a material which has a lower hardness than the material of the steering wheel frame.

Such a material may be a natural material or a synthetic material. Preferably, a leather and/or textile material, a softpaint and/or injection-molded and/or foamed thermoplastics and/or thermosetting plastics is/are used as a cover.

For the case where the cover alone is not yet sufficiently flexible and/or resilient for the desired haptic properties of the steering wheel to be fulfilled, preferably a layer made of a resilient material, in particular made of flexible foam, is arranged between the steering wheel frame and the cover. By a combination of such a layer with a corresponding cover, a plurality of steering wheel designs may be produced.

Further advantages and details of the invention are to be shown in more detail with reference to the accompanying drawings, in which:

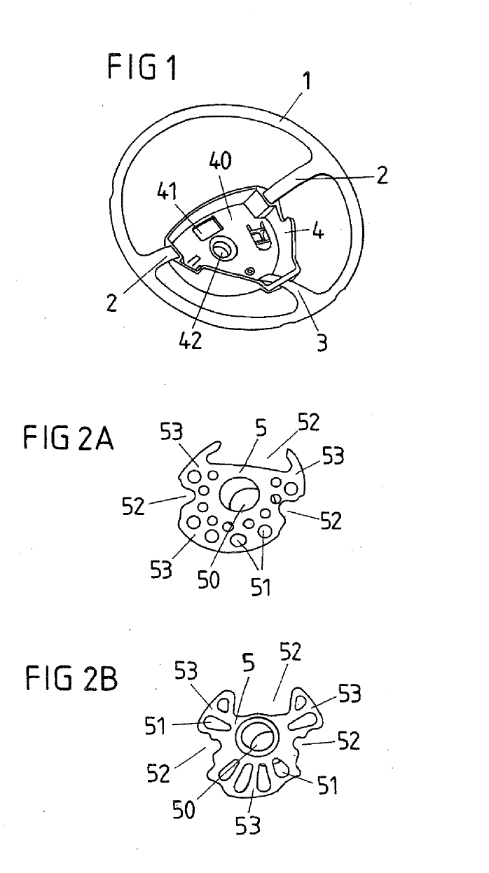

FIG. 1 shows a schematic representation of a steering wheel which has been produced by a method according to the invention,

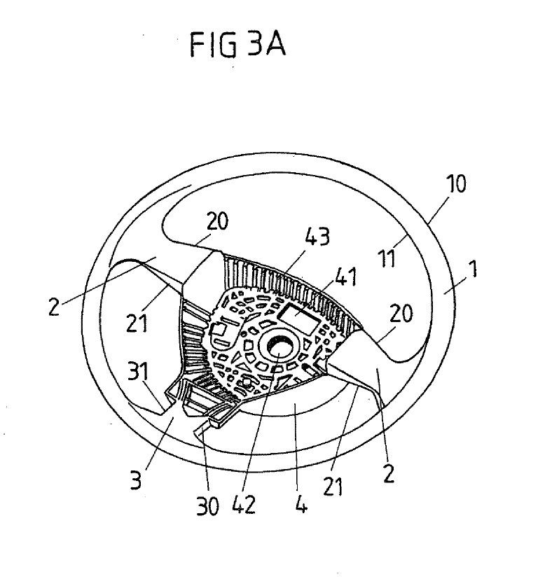

FIG. 2A shows a first exemplary embodiment of a hub insert for use in a method according to the invention or a steering wheel according to the invention,

FIG. 2B shows a second embodiment of a hub insert suitable for use in a method according to the invention or in a steering wheel according to the invention,

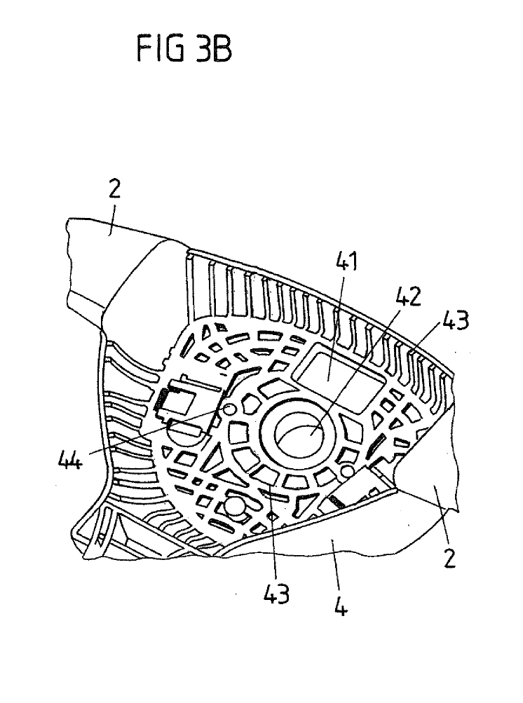

FIG. 3A shows a first embodiment of a steering wheel according to the invention in front view,

FIG. 3B shows a detailed view of the hub base of the steering wheel of FIG. 3A,

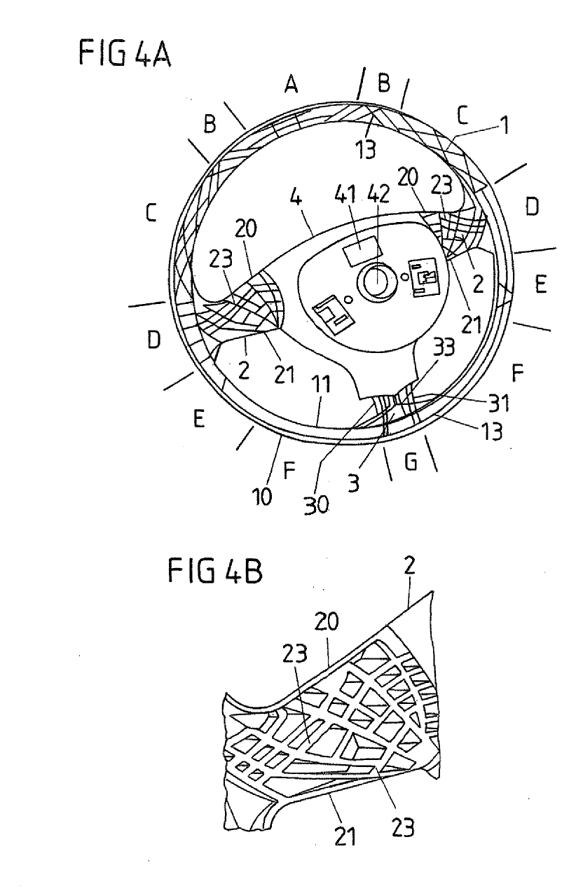

FIG. 4A shows the steering wheel of FIG. 3A in rear view,

FIG. 4B shows a detailed view of a side spoke from the steering wheel shown in FIG. 4A in rear view,

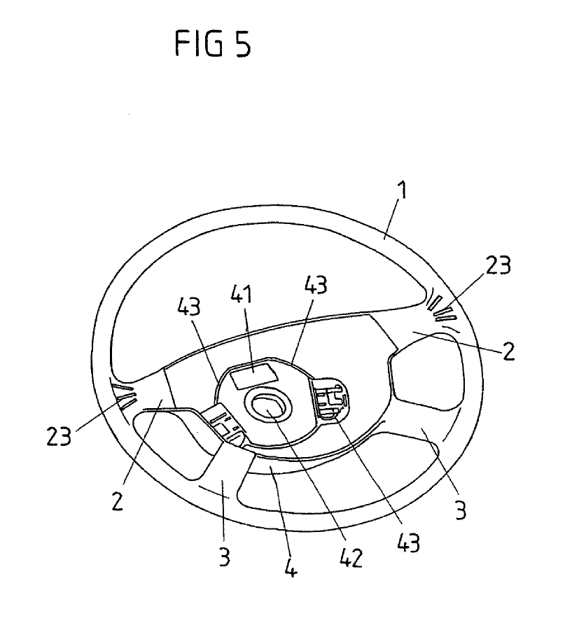

FIG. 5 shows a second embodiment of a steering wheel according to the invention in front view,

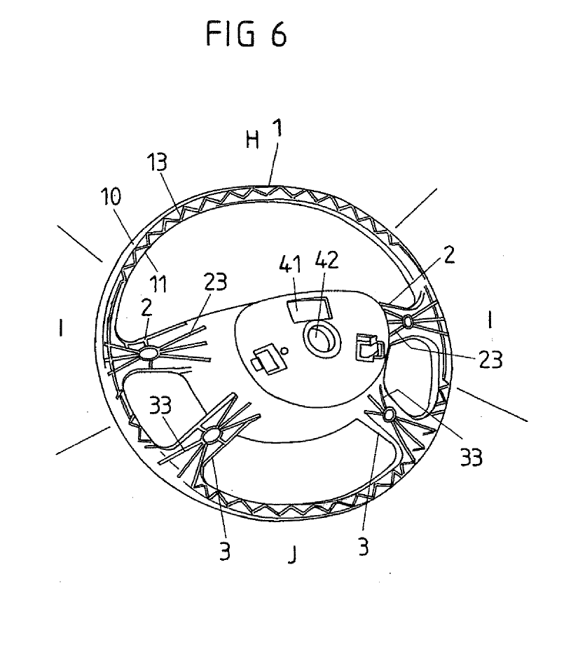

FIG. 6 shows the steering wheel of FIG. 5 in rear view,

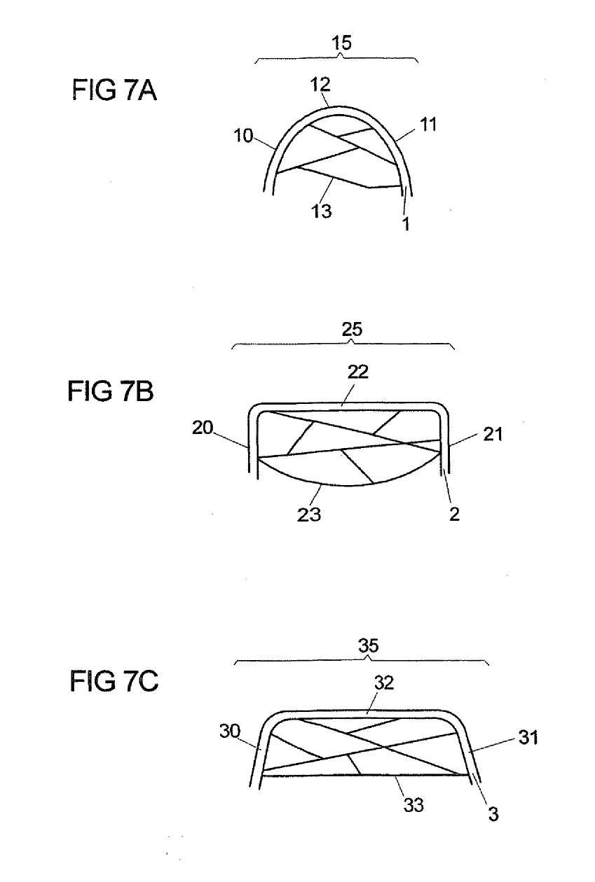

FIG. 7A shows a cross section through a steering wheel rim,

FIG. 7B shows a cross section through a side spoke and

FIG. 7C shows a cross section through a central spoke.

FIG. 1 shows a schematic representation of a steering wheel frame made up of a steering wheel rim 1, two side spokes 2, one central spoke 3, and a hub base 4 which has been produced according to a method according to the invention. In this case all parts of the steering wheel frame have been produced in an integrated injection-molding method. The side spokes 2 and the central spoke 3 connect the steering wheel rim 1 to the hub base 4. The hub base 4 has a bottom surface of the hub base 40 into which, amongst others, a rectangular recess 41 and a round recess 42 are incorporated. The through-passage and/or the recess 42 serve for receiving a steering shaft of the vehicle, in which the steering wheel is arranged.

The hub base 4 is cup-shaped so that further vehicle elements, such as for example an airbag module, may be inserted into the hub base 4. To this end, such an airbag module may be engaged in the usual manner in the hub base 4, for which corresponding latching devices are provided in the hub base 4 and/or on the bottom surface of the hub base 40. If an airbag module or a further vehicle element is intended to be screwed to the hub base 4, with the use of self-tapping screws, the precutting of threads may be omitted. By introducing sliding cores into the mold to be filled with a plastics matrix, during injection-molding undercuts may be directly produced, into which modules may be engaged. This considerably simplifies the production process relative to conventional production methods.

FIGS. 2A and 2B show possible embodiments of bushings which are inserted as a hub insert 5 in an inventive steering wheel or a steering wheel produced according to the invention. There is a great freedom of design in the production of the hub insert 5, with regard to geometry and material. A common feature of the different conceivable hub bodies 5 is a first opening 50 which is arranged on a central region of the hub insert 5 and which serves to receive the steering shaft of the vehicle, into which the steering wheel is intended to be inserted. During subsequent injection-molding of plastics around the hub insert 5, said first through-passage 50 remains, i.e. it is not covered by plastics. As a result, a through-passage is formed in the bottom surface of the hub base.

The hub insert 5 further comprises a plurality of second through-passages 51 of which in FIGS. 2A and 2B only two second through-passages 51 are provided by way of example with the corresponding reference numerals. The second through-passages 51 serve for weight reduction of the hub insert 5 and a more stable bond between the hub insert 5 and a plastics covering to be attached to the hub insert 5.

The hub insert 5 further comprises a plurality of recesses 52 on its radial external region. By these recesses 52 wing-like regions 53 of the hub insert 5 are formed separately from one another. By the formation of such wing-like regions 53, the force transmission from the steering wheel via the hub insert 5 to the steering shaft to be inserted into the first through-passage 50 of the hub insert 5 is increased.

FIG. 3A shows an embodiment of a steering wheel according to the invention which may be produced according to a method according to the invention for producing a steering wheel. For denoting the individual elements of this steering wheel the reference numerals already used in FIG. 1 are used.

Thus the steering wheel of FIG. 3A also has a steering wheel rim 1 with two side spokes 2 and a central spoke 3 which connect the steering wheel rim 1 to a hub base 4. The hub base 4 is arranged inside the steering wheel rim 1 and has a round recess 42 for receiving the steering shaft of the vehicle, in which the steering wheel is arranged, and a square recess 41. The hub base 4 is provided in its cup-shaped internal region with a plurality of reinforcing structures 43, which may be seen more clearly in the enlarged illustration of FIG. 3B. For improved clarity, in this case respectively only a few reinforcing structures are provided with the corresponding reference numerals, representing the remaining reinforcing structures.

In the region of the side walls of the hub base 4 the reinforcing structures are arranged substantially in the direction of the steering shaft which is inserted into the round recess 42 in the bottom surface of the hub base. In the region of the bottom surface of the hub base, the reinforcing structures 43 are arranged firstly surrounding each recess 41 and/or 42 and/or 44. Additionally to these annular reinforcing structures 43 further ribs are arranged as reinforcing structures 43 axially extending toward the round recess 42. Moreover, the bottom surface of the hub base has further reinforcing structures 43, which are arranged neither extending radially about a recess 41 and/or 42 and/or 44 nor axially toward such a recess 41 and/or 42 and/or 44. Thus a complex interwoven arrangement made up of reinforcing structures 43 results in the internal region of the hub base 4, which provides the hub base 4 with a high degree of stability.

Forces diverted from the steering wheel rim 1 via the spokes 2 and 3 to the hub base 4 and therefrom to the steering shaft of the vehicle are transmitted effectively in this manner and by maintaining a high degree of stability of the steering wheel. An arrangement of the reinforcing structures 43 relative to the internal region of the hub base 4 has, moreover, the advantage that, in the field of vision of the driver operating the steering wheel, the structural design of the steering wheel frame is not visible. Thus at the same time it is excluded that any differences in height of the reinforcing structures 43 are visible as sink marks on a subsequently applied cover of the steering wheel frame, in particular on the surface of the more flexible covering material.

By the arrangement of the reinforcing structures 43 and by considering the plastic material for producing the steering wheel frame—in particular by considering the fiber reinforcement of the plastic material—a steering wheel according to the invention achieves the known high stability in daily vehicle operation in addition to the stability which is necessary in order to withstand the stresses produced by faulty use or stresses produced by the occurrence of an accident. It is unlikely that this stability is able to be achieved simply by substituting the metal material, used hitherto for a steering wheel frame, for any plastics material.

In the region of the transition of the hub base 4 to the side spokes 2 and/or the central spoke 3, the stability of the hub base 4 is increased by additional reinforcing structures 43 arranged transversely to the arrangement of the reinforcing structures 43 on the side faces of the hub base 4.

In FIG. 4A a rear view of the steering wheel of FIG. 3A may be seen. For the description of the individual elements of the steering wheel of FIG. 4A, reference is made to the description of FIG. 3A. Additionally the design of the steering wheel frame may be even more clearly identified in this view.

Thus the steering wheel rim 1, the side spokes 2 and the central spoke 3 respectively have in cross section a U-shaped design with a first side limb 10, 20, 30 as a first side limb, a second side limb 11, 21, 31 as a second side limb and a limb connecting the two side limbs. The U-shaped design is in this case penetrated in the region encompassed by the U-shape by reinforcing structures 13, 23, 33. If one were to imagine deleting these reinforcing structures 13, 23, 33 from the cross section of the steering wheel rim 1, the side spokes 2 and the central spoke 3, a pure U-shape remains, which forms a receiver for the reinforcing structures 13, 23, 33. This is shown in detail in FIGS. 7A to 7C.

The limb connecting the two side limbs in the steering wheel of FIGS. 3A and 4A is arranged at the top, i.e. arranged toward the driver's side, whilst the open side of the U-shaped design of the steering wheel rim 1, the side spokes 2 and the central spoke 3 is arranged at the bottom. In this manner the steering wheel frame already has an enclosed surface toward the driver so that structural elements, such as for example the reinforcing structures 13, 23, 33, are not visible at the top. Overcoming the natural resonance of the steering wheel 1, which is a necessity, is achieved at the same time as a result of the cross-ribbing of the reinforcing structures 13, 23, 33. Also, it is thus prevented that sink marks become apparent in the flexible material of the cover which has to be attached to the steering wheel frame.

In the view of FIG. 4A, moreover, the different arrangements of reinforcing structures 13 in the region of the steering wheel rim 1, of reinforcing structures 23 in the region of the side spokes 2 and of reinforcing structures 33 in the region of the central spoke 3 may be easily seen. For improved clarity, respectively only a few of the reinforcing structures 13, 23, 33 are provided with the corresponding reference numerals.

Thus the steering wheel rim 1 may be divided into different zones A to G. In zone A arranged in the uppermost portion of the steering wheel rim 1, the reinforcing structures 13 are arranged in particular transversely and longitudinally to the limbs of the steering wheel rim 1.

In the adjacent zone B, to the right and to the left of zone A, the reinforcing structures 13 merge with an oblique arrangement, which hardly crosses over, from one limb 10 of the steering wheel rim 1 to the other limb 11 of the steering wheel rim 1.

In zone C, adjoining zone B of the steering wheel rim 1 at the bottom, the reinforcing structures 13 are arranged in an oblique arrangement, which clearly crosses over, from one side limb 10 of the steering wheel rim 1 to the other side limb 11 of the steering wheel rim 1.

Zone D adjoins zone C of the steering wheel rim 1 at the bottom. In this zone, a radial reinforcing structure 13 is located which is arranged approximately centrally between the two side limbs 10, 11 of the steering wheel rim 1. This radial reinforcing structure 13 is crossed by reinforcing structures 43 extending from the one side limb 10 of the steering wheel rim 1 transversely to the other side limb 11. Zone D mirrors in this case the region of the steering wheel rim 1 in which the side spokes 2 are attached to the steering wheel rim 1.

Zone E is attached below zone D, and in which the radial reinforcing structure 13 of zone D extends, but is crossed by reinforcing structures 13 extending obliquely from one side limb 10 of the steering wheel rim 1 to the other side limb 11 of the steering wheel rim 1.

Zone F adjoins zone E further below, in which the radially extending reinforcing structure 13 of zones D and E substantially extends without further reinforcing structures 13 crossing.

In the lowermost region of the steering wheel rim 1, in which the central spoke 3 is connected to the steering wheel rim 1, finally zone G of the steering wheel rim 1 is arranged in which the radial reinforcing structure 13 made up of zones D, E and F extends and is crossed by reinforcing structures 13 which extend in the longitudinal direction of extension of the central spoke 3.

In FIG. 4B, an enlarged view of a side spoke 2 of the steering wheel of FIG. 4A is also shown in rear view. In this view, the reinforcing structures 23 extending crossed and obliquely from one side limb 20 of the side spoke 2 to the other side limb 21 of the side spoke 2, may be easily seen. Again, only a few reinforcing structures 23 are provided with the corresponding reference numerals. According to the number and geometry of the side spokes 2 and their relative arrangement to the steering wheel rim 1, the reinforcing structures 23 may also adopt a different path in order to illustrate the corresponding load transfer paths.

FIG. 5 shows a further embodiment of a steering wheel according to the invention which has, in a similar manner to the steering wheel of FIG. 3A, a steering wheel rim 1 and two side spokes 2 as well as a hub base 4. The reference numerals already known from the previous description of the figures are again used for the same elements of the steering wheel. In contrast to the embodiment shown in FIG. 3A, the steering wheel of FIG. 5, however, has two central spokes 3. As a result, different force distribution paths result in the entire steering wheel.

As a result of the two central spokes 3, the bottom of the hub base 4 is stabilized such that it is possible to omit an arrangement of reinforcing structures arranged in the longitudinal direction of the steering shaft to be introduced into a round recess in the bottom surface of the hub base 42. Also in the bottom surface of the hub base, in which in addition to the round recess 42 a further square recess 41 is also arranged, it is possible to omit a plurality of reinforcing structures, which are present in the embodiment of FIG. 3A. A few reinforcing structures 43 which partially cross, by having T-shaped and/or Y-shaped connections to one another, are however formed for stabilizing the hub base 4 on the bottom surface of the hub base.

In the event that insufficient stabilizing of the hub base 4 is able to be achieved by the side spokes 2 and the central spokes 3, it is also possible, with such a four-spoke steering wheel design, to provide reinforcing structures in the inside of the hub base 4, arranged parallel to the longitudinal direction of extension of the steering shaft to be introduced into the round recess 42. As a result, a possible deformation of the hub base 4 is effectively avoided.

At the transition of the side spokes 2 with the steering wheel rim 1, reinforcing structures 23 are arranged on the upper face of the side spokes 2, which contribute to an effective force transmitting connection between the side spokes 2 and the steering wheel rim 1. The steering wheel rim 1 itself has an enclosed surface at the top, i.e. oriented toward the driver's side. This enclosed surface serves to receive reinforcing structures which are arranged on the rear face of the steering wheel rim 1, as may be seen from FIG. 6. The same applies to the design of the central spokes 3. Only the side spokes 2 also have—as already mentioned—reinforcing structures 23 on the side facing the driver. The greatest proportion of the reinforcing structures 23 is, however, arranged, even in the case of the side spokes 2, on the rear face, i.e. the side of the steering wheel remote from the driver, as is shown in more detail hereinafter in the description of FIG. 6.

FIG. 6 shows the steering wheel shown in FIG. 5 in rear view. The reinforcing structures 13, 23, 33 of the steering wheel rim 1, the side spokes 2 and the central spokes 3 may be easily seen. In contrast to the embodiment of a steering wheel according to the invention shown in FIGS. 3 and 4, the reinforcing structures 13, 23, 33 of the embodiment shown in FIGS. 5 and 6 of a steering wheel according to the invention are arranged to cross over to a lesser extent. This is a result, amongst others, of the fact that the load transfer paths extend differently in the steering wheel due to the additional arrangement of a further central spoke 3.

Thus reinforcing structures 23, 33 of the side spokes 2 and the central spokes 3 are arranged to extend radially toward an annular reinforcing structure centrally arranged in the side spokes 2 and/or the central spokes 3. By their connection with the reinforcing structure extending in an annular manner, they provide a crossed arrangement of the reinforcing structures 23, 33. Moreover, the reinforcing structures 23, 33 of the side spokes 2 and the central spokes 3 extend into the steering wheel rim 1 and at that point cross over the reinforcing structures 13 of the steering wheel rim 1 at the connecting points of the side spokes 2 with the steering wheel rim 1 and/or the central spokes 3 with the steering wheel rim 1.

The arrangement of the reinforcing structure 13 in the steering wheel rim 1 may be subdivided into different zones H to J in a similar manner to the embodiment already shown in FIG. 4A of a steering wheel according to the invention. In zone H arranged in the upper region of the steering wheel rim 1, the reinforcing structures 13 extend in a zig-zag-shaped pattern from a first side limb 10 of the receiver of the steering wheel rim 1 to a second side limb 11 of the receiver of the steering wheel rim 1 and back again. As a result of the connection of the reinforcing structures 13 to one another, either at the first or the second side limb, i.e. at the turning point of the zig-zag pattern, a similar stabilizing of the reinforcing structures 13 is achieved as by a crossed or cross-over arrangement of the reinforcing structures 13.

Zone I adjoins zone H on both sides therebelow, and in which the reinforcing structures 13 extend substantially centrally, radially in the steering wheel rim. In this case, they are crossed over by the reinforcing structures 23, which extend from the side spokes into the steering wheel rim 1.

FIG. 7A shows a schematic cross section through a partial region of a steering wheel rim 1 according to the invention with a first side limb 10, a second side limb 11 opposing the first side limb 10, and a central limb 12 which connects the first side limb 10 to the second side limb 11. The first side limb 10, the second side limb 11 and the central limb 12 form together a receiver 15 which receives the reinforcing structures 13 of the steering wheel rim 1 which partially cross. In this case, the reinforcing structures 13 may also partially project from the receiver 15 (see FIG. 7B). The cross section of the steering wheel rim 1 has the form of a rounded U-shape.

FIG. 7B shows a schematic cross section through a partial region of a side spoke 2 according to the invention, with a first side limb 20, a second side limb 21 opposing the first side limb 20 and a central limb 22 which connects the first side limb 20 to the second side limb 21. The first side limb 20, the second side limb 21 and the central limb 22 form together a receiver 25 which receives the reinforcing structures 23 of the side spoke 2 which partially cross and partially cross over. One portion of the reinforcing structures 23 projects from the receiver and thus forms the lower termination of the side spoke 2. The cross section of the side spoke 2 has the form of an angular U-shape, the side limbs 20, 21 also being able to be connected to the central limb 22 at a different angle from that shown in FIG. 7B.

FIG. 7C shows a schematic cross section through a partial region of a central spoke 3 according to the invention with a first side limb 30, a second side limb 31 opposing the first side limb 30, and a central limb 32 which connects the first side limb 30 to the second side limb 31. The first side limb 30, the second side limb 31 and the central limb 32 form together a receiver 35 which receives the reinforcing structures 33 of the central spoke 3 which partially cross and partially cross over. The cross section of the central spoke 3 also has the form of an angular U-shape, the side limbs 30, 31 also being able to be connected to the central limb 32 at a different angle from that shown in FIG. 7C.

### LIST OF REFERENCE NUMERALS

1 Steering wheel rim

2 Side spoke

3 Central spoke

4 Hub base

5 Hub insert

10 First side limb of the steering wheel rim

11 Second side limb of the steering wheel rim

12 Central limb of the steering wheel rim

13 Reinforcing structures

15 Receiver of the steering wheel rim

20 First side limb of the side spoke

21 Second side limb of the side spoke

22 Central limb of the side spoke

23 Reinforcing structures

25 Receiver of the side spoke

30 First side limb of the central spoke

31 Second side limb of the central spoke

32 Central limb of the central spoke

33 Reinforcing structures

35 Receiver of the central spoke

40 Bottom surface of the hub base

41 Rectangular recess in the bottom surface of the hub base

42 Round recess in the bottom surface of the hub base

44 Further round recess in the bottom surface of the hub base

43 Reinforcing structures

50 First through-passage

51 Second through-passage

52 Recess

53 Wing-like region

A Zone of the steering wheel rim

B Zone of the steering wheel rim

C Zone of the steering wheel rim

D Zone of the steering wheel rim

E Zone of the steering wheel rim

F Zone of the steering wheel rim

G Zone of the steering wheel rim

H Zone of the steering wheel rim

I Zone of the steering wheel rim

J Zone of the steering wheel rim

1. A method for producing a steering wheel for a vehicle, in particular for a motor vehicle, characterized by the following steps:
a) producing a steering wheel frame with a hub base, a steering wheel rim and at least one spoke by
aa) providing a hub insert,
ab) injection-molding a plastics matrix around the hub insert for forming the hub base, the hub base having a cavity-like shape forming an internal region and reinforcing structures being arranged in the internal region of the hub base,
ac) injection-molding and/or gas-assisted injection-molding and/or water injection-molding of the at least one spoke and of the steering wheel rim from the plastics matrix, the at least one spoke connecting the hub base to the steering wheel rim, and
b) at least partial covering of the steering wheel frame with a cover.

2. The method as claimed in claim 1, characterized in that the hub base is painted between step a) and step b).

3. The method as claimed in claim 1, characterized in that before step b) a layer of a resilient material is applied to the steering wheel frame.

4. The method as claimed in claim 1, characterized in that the plastics matrix has at least one thermoplastic plastic.

5. The method as claimed in claim 4, characterized in that the thermoplastic plastic is polypropylene, polybutylene terephthalate or a polyamide.

6. The method as claimed in claim 1, characterized in that the plastics matrix has a component of 5 to 80%, in particular 10 to 70%, particularly 20 to 60% of a fiber material.

7. The method as claimed in claim 6, characterized in that the fiber material has carbon fibers, metal fibers, fibers of organic products and/or glass fibers.

8. The method as claimed in claim 7, characterized in that the glass fibers have a diameter of 1 to 60 μm, in particular of 3 to 40 μm, particularly of 5 to 20 μm.

9. The method as claimed in claim 7, characterized in that the injection-molding is carried out such that at least 50% of the glass fibers in the plastics matrix of the steering wheel frame have a length of at least 1 mm, in particular of 1 to 20 mm, quite particularly of 1 to 5 mm.

10. The method as claimed in claim 1, characterized in that for the injection-molding an extrusion device is used, which has at least one supply device for supplying the plastics matrix and/or a plastics matrix component and a conveyor worm for conveying the plastics matrix and/or the plastics matrix component, the regions, which are flowed through by the plastics matrix to be melted and/or by the melted plastics matrix, having cross sections which are selected to be sufficiently large that damage to the fiber material in the plastics matrix is minimized.

11. The method as claimed in claim 10, characterized in that a fiber-free plastics matrix component and the fiber material are supplied to the extrusion device separately from one another, the fiber material being introduced into the already melted fiber-free plastics matrix component.

12. The method as claimed in claim 1, characterized in that the steering wheel frame is covered with the cover without carrying out a washing step.

13. The method as claimed in claim 1, characterized in that the covering of the steering wheel frame with the cover takes place by injection-molding, by a reaction method and/or by a manual mechanical method.

14. The method as claimed in claim 1, characterized in that the cover has a leather and/or textile material, a softpaint and/or injection-molded and/or foamed thermoplastics and/or thermosetting plastics.

15. A steering wheel for a vehicle, in particular for a motor vehicle, with a steering wheel frame, which comprises a steering wheel rim, a hub base and at least one spoke, by means of which the hub base is connected to the steering wheel rim, the hub base being arranged inside the steering wheel rim and the steering wheel rim and the at least one spoke substantially only consisting of a plastics matrix, characterized in that
a) the at least one spoke comprises reinforcing structures and
b) the hub base comprises a cavity-like shape forming an internal region, reinforcing structures being arranged in the internal region of the hub base.

16. The steering wheel as claimed in claim 15, characterized in that the steering wheel rim has an enclosed surface which completely surrounds a cavity without reinforcing structures.

17. The steering wheel as claimed in claim 15, characterized in that the steering wheel rim has reinforcing structures.

18. The steering wheel as claimed in claim 15, characterized in that the reinforcing structures have a rib-like design.

19. The steering wheel as claimed in claim 15, characterized in that the reinforcing structures are arranged along the load transfer paths in the steering wheel.

20. The steering wheel as claimed in claim 15, characterized in that the steering wheel rim has reinforcing structures, and the reinforcing structures of the steering wheel rim and/or the at least one spoke are configured partially crossed.

21. The steering wheel as claimed in claim 15, characterized in that the steering wheel rim and/or the at least one spoke have a receiver formed by a first side limb, a second side limb opposing the first side limb and a central limb which connects the first side limb to the second side limb.

22. The steering wheel as claimed in claim 21, characterized in that the steering wheel rim has reinforcing structures, and at least one portion of the reinforcing structures of the steering wheel rim and/or the at least one spoke is arranged inside the receiver.

23. The steering wheel as claimed in claim 21, characterized in that the receiver of the steering wheel rim and/or the at least one spoke has an enclosed surface.

24. The steering wheel as claimed in claim 21, characterized in that the receiver of the steering wheel rim and/or the at least one spoke has a U-shaped form in cross section.

25. The steering wheel as claimed in claim 21, characterized in that the reinforcing structures in the region of the at least one spoke extend at least partially obliquely from the first side limb of the receiver to the second side limb of the receiver.

26. The steering wheel as claimed in claim 21, characterized in that the reinforcing structures extend in the region of the at least one spoke substantially longitudinally and transversely to the side limbs of the receiver.

27. The steering wheel as claimed in claim 21, characterized in that reinforcing structures are arranged in the region of the steering wheel rim at least partially obliquely from the first side limb of the receiver to the second side limb of the receiver and/or parallel to the two side limbs of the receiver and/or transversely to the two side limbs of the receiver.

28. The steering wheel as claimed in claim 15, characterized in that the hub base has a hub insert which is at least partially embedded in the plastics matrix.

29. The steering wheel as claimed in claim 28, characterized in that the hub insert comprises at least one metal.

30. The steering wheel as claimed in claim 28, characterized in that the hub insert has at least one recess so that it fills up less than the entire bottom surface of the hub base.

31. The steering wheel as claimed in claim 28, characterized in that the hub insert has at least one first through-passage for receiving a steering shaft, which is not embedded in the plastics matrix.

32. The steering wheel as claimed in claim 31, characterized in that the reinforcing structures of the hub base are at least partially arranged in an annular manner around the first through-passage.

33. The steering wheel as claimed in claim 31, characterized in that the reinforcing structures of the hub base are arranged extending at least partially axially toward the first through-passage.

34. The steering wheel as claimed in claim 31, characterized in that the reinforcing structures extend on the side faces of the hub base substantially in the longitudinal direction of extension of the steering shaft to be inserted into the first through-passage.

35. The steering wheel as claimed in claim 29, characterized in that the hub insert has at least one second through-passage which is embedded non-positively in the plastics matrix.

36. The steering wheel as claimed in claim 28, characterized in that a reinforcing structure is arranged surrounding each opening in the bottom surface of the hub base which is formed by the hub insert and the plastics matrix embedding said hub insert.

37. The steering wheel as claimed in claim 28, characterized in that the ratio between the material thickness of the hub insert and the material thickness of the bottom surface of the hub base, which is formed by the hub insert and the plastics matrix embedding said hub insert, is in the range of 5:1 to 1:5, in particular 1:2.5.

38. The steering wheel as claimed in claim 15, characterized in that the plastics matrix has a component of 5 to 80%, in particular 10 to 70%, particularly 20 to 60% of a fiber material.

39. The steering wheel as claimed in claim 38, characterized in that the fiber material has carbon fibers, metal fibers, fibers of organic products and/or glass fibers.

40. The steering wheel as claimed in claim 39, characterized in that at least 50% of the glass fibers in the plastics matrix of the steering wheel frame have a length of at least 1 mm, in particular of 1 to 20 mm, quite particularly of 1 to 5 mm.

41. The steering wheel as claimed in claim 15, characterized in that a cover for the steering wheel frame has a thickness of 1 to 5 mm, in particular 1 to 3 mm and particularly 1 to 2 mm.

42. The steering wheel as claimed in claim 15, characterized in that a cover for the steering wheel frame is made of a material which has a lower hardness than the material of the steering wheel frame.

43. The steering wheel as claimed in claim 15, characterized in that a cover for the steering wheel frame has a leather and/or textile material, a softpaint and/or injection-molded and/or foamed thermoplastics and/or thermosetting plastics.

44. The steering wheel as claimed in claim 15, characterized in that a layer made of a resilient material, in particular made of flexible foam, is arranged between the steering wheel frame and a cover therefor.
